(19) United States
(12) Patent Application Publication
(10) Pub. No.: US 2009/0246534 A1
(43) Pub. Date: Oct. 1, 2009

(54) CURABLE COMPOSITIONS

(75) Inventors: Thomas J. Staunton, Euclid, OH (US); Zhicheng Li, Solon, OH (US); Robert W. Green, Chagrin Falls, OH (US); Weilin Tang, Solon, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 12/409,560

(22) Filed: Mar. 24, 2009

Related U.S. Application Data
(60) Provisional application No. 61/041,335, filed on Apr. 1, 2008.

(51) Int. Cl. B32B 27/40; C08K 5/09

(52) U.S. Cl. 428/423.1; 524/300

(57) ABSTRACT

This invention relates to a curable composition comprising a solvent solution of a mixture comprising:
(i) at least one hydroxy-functional acrylic polymer having a Tg of about 25° C. or lower; and
(ii) at least one hydroxy-functional polyester having a Tg of 0° C. or lower;
(iii) at least one polyisocyanate having an average functionality of ≧4;
(iv) a metal catalyst, such as a tin compound, for accelerating the isocyanate/hydroxyl reaction; and
(v) optionally a pot-life extending amount of propionic acid.

### CROSS REFERENCE TO RELATED APPLICATIONS

This application claims the benefit of co-pending U.S. Provisional Application 61/041,335 filed Apr. 1, 2008, the entirety of which is hereby incorporated by reference.

### SUMMARY OF THE INVENTION

This invention relates to a curable composition comprising a solvent solution of a mixture comprising:
(i) at least one hydroxy-functional acrylic polymer having a Tg of about 25° C. or lower;
(ii) at least one hydroxy-functional polyester having a Tg of 0° C. or lower;
(iii) at least one polyisocyanate having an average functionality of ≧4.0;
(iv) a metal catalyst, such as a tin compound, for accelerating the isocyanate/hydroxyl reaction; and
(v) optionally, a pot-life extending amount of propionic acid.

### DETAILED DESCRIPTION OF THE INVENTION

The curable compositions of this invention are especially useful as coatings and may typically be utilized as primers, topcoats or as clearcoats and/or basecoats in clearcoat/basecoat compositions and are especially useful in spray applications. The compositions of this invention could also be utilized as adhesives, elastomers and plastics.

When utilized as a coating or an adhesive, the curable composition of this invention will be used in combination with about 5 to about 80%, and preferably 10 to about 40%, by weight of an inert solvent. In one useful embodiment, the curable composition has a sprayable viscosity less than about 25 seconds, for example, less than about 20 seconds, when measured by a #2 Zahn cup at room temperature and when formulated to a VOC level of 3.5#/gallon. It is convenient to provide the curable composition as a multicomponent system, which is reactive upon mixing the components. Generally, the active hydrogen-containing components (e.g. the acrylic polyol and the polyester) and the polyisocyanate component will be maintained in separate packages and mixed just prior to use. In one useful embodiment, when mixed together in a single package, the active hydrogen containing component comprises about 50% to about 80% by weight of the hydroxy-functional acrylic resin, for example about 60% to about 70%. Further, active hydrogen component may comprise at least about 20% by weight of a hydroxy-functional polyester, for example about 30% to about 50%, further for example, about 30% to about 40%. In some embodiments, the pot-life of the mixture can be extended without adversely affecting cure or other properties of the final cured product by the addition of propionic acid. The metal catalyst can be incorporated into either component, or into a diluting solvent ahead of time. In one embodiment, the propionic acid may be added to the active hydrogen-containing portion or the diluting solvent rather than the polyisocyanate portion.

Each of the components of the present invention will be described in greater detail below.

### 1. Hydroxy-Functional Acrylic Polymers.

For many applications, especially those requiring a minimum amount of solvent, the hydroxy-functional acrylic polymers useful in this invention will have an average of at least two active hydrogen groups per molecule and a number average molecular weight less than about 5,000, and for example less than about 3,000.

The hydroxy-functional acrylic polymers can be conveniently prepared by free radical polymerization techniques as is well known in the art. The acrylic polymers are typically prepared by the addition polymerization of one or more monomers. At least one of the monomers will contain, or can be reacted to produce, a reactive hydroxyl group. Representative hydroxy-functional monomers include 2-hydroxyethyl acrylate, 2-hydroxyethyl methacrylate, 2-hydroxypropyl acrylate, 4-hydroxybutyl methacrylate, 2-hydroxypropyl methacrylate, 3-hydroxybutyl acrylate, 4-hydroxypentyl acrylate, 2-hydroxyethyl ethacrylate, 3-hydroxybutyl methacrylate, 2-hydroxyethyl chloroacrylate, diethylene glycol methacrylate, tetraethylene glycol acrylate, para-vinyl benzyl alcohol, etc. Typically the hydroxy-functional monomers would be copolymerized with one or more monomers having ethylenic unsaturation such as:
(i) esters of acrylic, methacrylic, crotonic, tiglic, or other unsaturated acids such as: methyl acrylate, ethyl acrylate, propyl acrylate, isopropyl acrylate, butyl acrylate, isobutyl acrylate, ethylhexyl acrylate, amyl acrylate, 3,5,5-trimethylhexyl acrylate, methyl methacrylate, ethylmethacrylate, propyl methacrylate, dimethylaminoethyl methacrylate, isobornyl methacrylate, ethyl tiglate, methyl crotonate, ethyl crotonate, etc.;
(ii) vinyl compounds such as vinyl acetate, vinyl propionate, vinyl butyrate, vinyl isobutyrate, vinyl benzoate, vinyl m-chlorobenzoate, vinyl p-methoxybenzoate, vinyl alpha-chloroacetate, vinyl toluene, vinyl chloride, etc.;
(iii) styrene-based materials such as styrene, alpha-methyl styrene, alpha-ethyl styrene, alpha-bromo styrene, 2,6-dichlorostyrene, etc.;
(iv) allyl compounds such as allyl chloride, allyl acetate, allyl benzoate, allyl methacrylate, etc.;
(v) other copolymerizable unsaturated monomers such as ethylene acrylonitrile, methacrylonitrile, dimethyl maleate, isopropenyl acetate, isopropenyl isobutyrate, acrylamide, methacrylamide, dienes such as 1,3-butadiene, and halogenated materials such as 2-(N-ethylperflourooctenesulfonamido)ethyl(meth)acrylate.

The polymers are conveniently prepared by conventional free radical addition polymerization techniques. Frequently, the polymerization will be initiated by conventional initiators known in the art to generate a free radical such as azobis(isobutyronitrile), cumene hydroperoxide, t-butyl perbenzoate, etc. Typically, the monomers are heated in the presence of the initiator at temperatures ranging from about 35° C. to about 200° C., and especially 75° C. to 150° C., to effect the polymerization. The molecular weight of the polymer can be controlled, if desired, by the monomer selection, reaction temperature and time, and/or the use of chain transfer agents as is well known in the art.

In one useful embodiment, the monomers are selected such that the resulting hydroxy-functional acrylic polymer will have a Tg that is at or below room temperature. For example, the hydroxy-functional acrylic polymer may have a Tg of about 25° C. or less.

### 2. Hydroxy-Functional Polyester

Useful hydroxy-functional polyesters may include polyesters having a number average molecular weight of less than about 3,000, for example about 200 to about 2000.

The methods of making polyester resins are well-known. Typically, a polyol component and an acid and/or anhydride component are heated together, optionally with a catalyst, and usually with removal of the by-product water in order to drive the reaction to completion. In general, the polyol component may have an average functionality of at least about two. The polyol component may contain mono-functional, di-functional, tri-functional, and higher functional alcohols. In one embodiment, diols may be used. In another embodiment, when some branching of the polyester is desired, higher functionality alcohols may be used. Illustrative examples of such include, without limitation, alkylene glycols and polyalkylene glycols such as ethylene glycol, propylene glycol, diethylene glycol, triethylene glycol, and neopentyl glycol, 1,4-butanediol, 1,6-hexanediol, 1,4-cyclohexane dimethanol, glycerine, trimethylolpropane, trimethylolethane, pentaerythritol, 2,2,4-trimethyl-1,3-pentanediol, hydrogenated bisphenol A, and hydroxyalkylated bisphenols. polyether polyols, polycaprolactone polyols and saturated and unsaturated polyols. Representative polyol diluents include diols such as ethylene glycol, dipropylene glycol, 2,2,4-trimethyl 1,3-pentanediol, neopentyl glycol, 1,2-propanediol, 1,4-butanediol, 1,3-butanediol, 2,3-butanediol, 1,5-pentanediol, 1,6-hexanediol, 2,2-dimethyl-1,3 -propanediol, 1,4-cyclohexanedimethanol, 1,2-cyclohexanedimethanol, 1,3-cyclohexanedimethanol, 1,4-bis(2-hydroxyethoxy)cyclohexane, trimethylene glycol, tetramethylene glycol, pentamethylene glycol, hexamethylene glycol, decamethylene glycol, diethylene glycol, triethylene glycol, tetraethylene glycol, norbornylene glycol, 1,4-benzenedimethanol, 1,4-benzenediethanol, 2,4-dimethyl-2-ethylenehexane-1,3-diol, 2-butene-1,4-diol, and polyols such as trimethylolethane, trimethylolpropane, trimethylolhexane, triethylolpropane, 1,2,4-butanetriol, glycerol, pentaerythritol, dipentaerythritol, etc.

The acid and/or anhydride component may comprise compounds having an average at least two carboxylic acid groups and/or anhydrides of these. In some embodiments, dicarboxylic acids or anhydrides of dicarboxylic acids may be used. However, higher functional acid and anhydrides may also be used when some branching of the polyester is desired. Suitable polycarboxylic acid or anhydride compounds include, without limitation, those having from about 3 to about 20 carbon atoms. Illustrative examples of suitable compounds include, without limitation, phthalic acid, isophthalic acid, terephthalic acid, hexahydrophthalic acid, tetrahydrophthalic acid, pyromellitic acid, succinic acid, azeleic acid, adipic acid, 1,4-cyclohexanedicarboxylic acid, dodecane-1,12-dicarboxylic acid, citric acid, trimellitic acid, and anhydrides thereof.

In one useful embodiment, the hydroxy-functional polyester may comprise a polycaprolactone polyester polyol formed by the lactone or polycaprolactone ring opening polymerization initiated by a multi-functional alcohol.

For example, the ring opening polymerization of caprolactone initiated by multi-functional alcohols such as trimethylolpropane (TMP), ethylene glycol (EG), diethylene glycol (DEG), or neo-pentyl glycol (NPG). The ring opening polymerization of caprolactone initiated by TMP forms a tri-functional caprolactone polyester polyol. The ring opening polymerization of caprolactone initiated by EG, DEG or NPG forms a di-functional caprolactone polyester polyol.

Examples of commercially available polycaprolactone polyester polyols include TONE 310 and TONE 305 available from Dow, Poly-T 309 and Poly-T 305 available from Arch Chemical, and CAPA 3091 available from Perstop (formerly Solvay).

### 3. Polyisocyanate Compounds.

Polyisocyanates useful in the compositions of this invention have an average of at least about four isocyanate groups per molecule. The polyisocyanate crosslinkers may be prepared by modifying simple aliphatic, cycloaliphatic, araliphatic and/or aromatic diisocyanates, being constructed from at least two diisocyanates, and having a uretdione, isocyanurate, allophanate, biuret, iminooxadiazinedione and/or oxadiazinetrione structure.

Suitable diisocyanates for preparing such polyisocyanates are any desired diisocyanates of the molecular weight range 140 to 400 g/mol that are obtainable by phosgenation or by phosgene-free processes, as for example by thermal urethane cleavage, and have aliphatically, cycloaliphatically, araliphatically and/or aromatically attached isocyanate groups, such as 1,4-diisocyanatobutane, 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1 -isocyanato-3,3,5-trimethyl-5-isocyanato-methylcyclohexane (isophorone diisocyanate, IPDI), 4,4′-diisocyanatodicyclohexylmethane, 1-isocyanato-1-methyl-4(3)-isocyanatomethylcyclohexane, bis(isocyanatomethyl)norbomane, 1,3- and 1,4-bis(2-isocyanatoprop-2-yl)benzene (TMXDI), 2,4- and 2,6-diisocyanatotoluene (TDI), 2,4′- and 4,4′-diisocyanatodiphenylnethane (MDI), 1,5-diisocyanatonaphthalene or any desired mixtures of such diisocyanates.

Useful polyisocyanates or polyisocyanate mixtures may conatin exclusively aliphatically and/or cycloaliphatically attached isocyante groups. In one embodiment of the invention, a polyisocyanate mixture may be used which contains a mixture of polyisocyanates having an average functionality of about 4.0 or greater than about 4.0, but which includes isocyanates having functionalities of 3, 4, 5, 6, and 7.

In one useful embodiment, the crosslinking component is selected from polyisocyanates based on HDI, but may also include polyisocyanates based on IPDI and/or 4,4′-diisocyanato-dicyclohexamethane.

The ratio of equivalents of isocyanate to active hydrogen can be widely varied within the practice of this invention. The polyisocyanate will typically be present at a level to provide about 0.3 to about 2.0, for example, about 0.9 to about 1.3, and further for example about 1 to about 1.1 equivalents of isocyanate for each equivalent of active hydrogen from the acrylic resin and polyester.

The curable compositions of this invention can be cured at temperatures ranging from about room temperature up to about 350° F. In one useful embodiment, the final crosslinked film of a coating composition resulting from the curable composition of the present invention may have a Tg of about 15 to about 40° C. If used as coatings, the curable compositions can be used as clear coatings or they may contain pigments as is well known in the art. Representative opacifying pigments include white pigments such as titanium dioxide, zinc oxide, antimony oxide, etc. and organic or inorganic chromatic pigments such as iron oxide, carbon black, phthalocyanine blue, etc. The coatings may also contain extender pigments such as calcium carbonate, clay, silica, talc, etc.

The coatings may also contain other additives such as flow agents, catalysts, solvents, ultraviolet light absorbers, etc. Typical metal catalysts for the reaction between the polyisocyanate and the active hydrogen-containing material include tin, zinc and copper materials such as dibutyl tin dilaurate, zinc octoate, and copper naphthenate. Organometallic tin compounds, such as dibutyltin dilaurate, are useful in the practice of this invention.

The coating composition of the present invention may also optionally comprise cyclohexane dimethanol at amounts of up to about 10% by weight of the total solids of the curable composition.

The coatings of this invention may typically be applied to any substrate such as metal, plastic, wood, glass, synthetic fibers, etc. by brushing, dipping, roll coating, flow coating, spraying or other method conventionally employed in the coating industry. If desired, the substrates may be primed prior to application of the coatings of this invention.

The benefits of adding propionic acid to a curable composition as described herein are described in more detail in U.S. Pat. No. 7,279,525, which is assigned to the assignee of the present application, and which is incorporated herein by reference.

One preferred application of the curable compositions of this invention relates to their use as clearcoats and/or basecoats in clearcoat/basecoat formulations. Low VOC clearcoats are an especially useful application of this invention.

Clearcoat/basecoat systems are well known, especially in the automobile industry where it is especially useful to apply a pigmented basecoat, which may contain metallic pigments, to a substrate and allow it to form a film followed by the application of a clearcoat. The basecoat composition may comprise any of the polymers known to be useful in coating compositions including the reactive compositions of this invention.

One useful polymer basecoat includes the acrylic addition polymers, particularly polymers or copolymers of one or more alkyl esters of acrylic acid or methacrylic acid, optionally together with one or more other ethylenically unsaturated monomers. These polymers may be of either the thermoplastic type or the thermosetting, crosslinking type which contain hydroxyl or amine or other reactive functionality which can be crosslinked. Suitable acrylic esters for either type of polymer include methyl methacrylate, ethyl methacrylate, propyl methacrylate, butyl methacrylate, ethyl acrylate, butyl acrylate, vinyl acetate, acrylonitrile, acrylamide, styrene, vinyl chloride, etc. Where the polymers are required to be of the crosslinking type, suitable functional monomers which can be used in addition to those already mentioned include acrylic or methacrylic acid, hydroxy ethyl acrylate, 2-hydroxy propyl methacrylate, glycidyl acrylate, tertiary-butyl amino ethyl methacrylate, etc. The basecoat composition may, in such a case, also contain a crosslinking agent such as a polyisocyanate, a polyepoxide, or a nitrogen resin such as a condensate of an aldehyde such as formaldehyde with a nitrogeneous compound such as urea, melamine or benzoguanamine or a lower alkyl ether of such a condensate. Other polymers useful in the basecoat composition include vinyl copolymers such as copolymers of vinyl esters of inorganic or organic acids, such as vinyl chloride, vinyl acetate, vinyl propionate, etc., which copolymers may optionally be partially hydrolyzed so as to introduce vinyl alcohol units.

Other polymers useful in the manufacture of the basecoat include alkyd resins or polyesters which can be prepared in a known manner by the condensation of polyhydric alcohols and polycarboxylic acids, with or without the inclusion of natural drying oil fatty acids as described elsewhere in this specification. The polyesters or alkyds may contain a proportion of free hydroxyl and/or groups which are available for reaction, if desired with suitable crosslinking agents as discussed above.

If desired, the basecoat composition may also contain minor amounts of a cellulose ester, to alter the drying or viscosity characteristics of the basecoat.

Typically, the basecoat will include pigments conventionally used for coating compositions and after being applied to a substrate, which may or may not previously have been primed, the basecoat will be allowed sufficient time to form a polymer film which will not be lifted during the application of the clearcoat. The basecoat may be heated or merely allowed to air-dry to form the film. Generally, the basecoat will be allowed to dry for about 1 to 20 minutes before application of the clearcoat. The clearcoat is then applied to the surface of the basecoat, and the system can be allowed to dry at room temperature or, if desired, can be force dried by baking the coated substrate at temperatures typically ranging up to about 350° F.

Typically, the clearcoat may contain ultraviolet light absorbers such as hindered phenols or hindered amines at a level ranging up to about 6% by weight of the vehicle solids as is known in the art. The clearcoat can be applied by any application method known in the art, but preferably will be spray applied. If desired, multiple layers of basecoat and/or clearcoat can be applied. Typically, both the basecoat and the clearcoat will each be applied to give a dry film thickness of about 0.2 to about 6, and especially about 0.5 to about 3.0, mils.

If desired, the novel reactive compositions taught herein could be used as a basecoat, in which case the clearcoat could also comprise the novel reactive coatings taught herein, or the polymers taught herein as being useful as basecoat formulations could be utilized as clearcoats.

When used as a clearcoat, it is desirable for the reactive composition of the present invention to dry to have a microhardness of at least about 25, for example, at least about 30 N/mm² (Universal Hardness units measured using a Fischerscope H100 unit manufactured by Helmut Fischer GmbH & Co.).

The following examples have been selected to illustrate specific embodiments and practices of advantage to a more complete understanding of the invention. Unless otherwise stated, “parts” means parts-by-weight and “percent” is percent-by-weight.

### EXAMPLE 1

A representative acrylic polymer was prepared by the free radical polymerization reaction of the following materials in the presence of aromatic naphtha and N-butyl acetate

| Raw Material | Parts by Weight |
|---|---|
| T-Amylethylhexylperoxycarbonate | 34.14 |
| Methyl Methacrylate | 106.17 |
| Butyl Acrylate | 159.14 |
| Hydroxy Ethyl Methacrylate | 151.11 |
| Styrene | 110.95 |
| Methacrylic Acid | 3.27 |

to produce a polymer having a weight/gallon of about 8.75 at 70% NVM.

### EXAMPLE 2

Three clearcoats were prepared by admixing the following materials:

| | A | B | C |
|---|---|---|---|
| Raw Material | Parts by weight | Parts by wt | Parts by wt |
| Acrylic Resin of Example 1 (Tg of 25° C.) | 46.76 | 46.76 | 46.76 |
| Polycaprolactone polyester polyol (melting range | 14.03 | 14.03 | 14.03 |
| 0-10° C.) | | | |
| Methyl n-propyl ketone | 3.14 | 3.14 | 3.14 |
| n-butyl acetate | 7.29 | 14.59 | 13.49 |
| Methyl amyl ketone | 21.33 | 21.33 | 21.33 |
| Tiniuvin ® 5350 (light stabilizer from Ciba-Geigy) | 2.35 | 2.35 | 2.35 |
| Dibutyl tin dilaurate (2% solution) | 1.57 | 1.57 | 1.57 |
| Acrylate Flow Additive (Chempol A620A2 from | 0.03 | 0.03 | 0.03 |
| CCP) | | | |
| BYK-310 flow additive from BYK | 0.31 | 0.31 | 0.31 |
| Propionic acid | 0.38 | 0.38 | 0.38 |
| Tolonate ® HDT LV (HDI Trimer from Rhodia - | 29.50 | | |
| 80% solids with n-butyl acetate) Average | | | |
| Functionality 3.2 | | | |
| Desmodur ® N-3300 (HDI Trimer from Bayer | | 25.50 | |
| Material Science) Average Functionality 3.5 | | | |
| Desmodur ® N3790BA (Aliphatic Polyisocyanate | | | 31.30 |
| from Bayer Material Science) Average | | | |
| Functionality 4.1 | | | |

E-coated CRS panels were coated with an black basecoat (Sherwin-Williams ULTRA basecoat), flashed for 30 minutes at room temperature and then clear coated using a 2 coat process with a 2 minute flash time between coats. After a 2 hour flash time at room temperature, the coatings were cured at 140° F. for 15.5 hours. The microhardness of the coatings were measured using a Fischerscope H100 unit. Clearcoat A had a microhardness of 19.5 N/mm², clearcoat B had a microhardness of 21.4 N/mm² and clearcoat C had a microhardness of 30.5 N/mm².

In addition, the scratch resistance of each clearcoat was determined by scratching each coated surface using 10 cycles of crockmeter with 3M218Q wet or dry polish sheets (grad 9MIC) then measuring the gloss using a BYK-Gardner Tri-Gloss meter at 20° (results are in gloss units):

TABLE 1

| | | A | B | C |
|---|---|---|---|---|
| 75° F./50% Relative Humidity | Initial | 85.7 | 85.9 | 86 |
| | 1 min recovery | 80 | 67.3 | 63.1 |
| | 5 min recovery | 81.8 | 77.9 | 76.4 |
| | 30 min recovery | 82.1 | 79.1 | 81.2 |

In general, without being limited to any particular theory, it is believed that coatings with greater microhardness exhibit less scratch resistance. As shown by the above table, the present invention retains a comparable level of gloss retention after scratch to softer coatings.

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

The entire disclosures of all applications, patents and publications cited herein are hereby incorporated by reference.

The invention claimed is:

1. A curable composition comprising a solvent solution of a mixture comprising:
(i) at least one hydroxy-functional acrylic polymer having a Tg of about 25° or lower;
(ii) at least one hydroxy-functional polyester having a Tg of 0° or lower;
(iii) at least one polyisocyanate having an average isocyanate functionality of ≧4;
(iv) a metal catalyst for accelerating the isocyanate/hydroxyl reaction; and
(v) propionic acid.

2. The composition of claim 1 wherein the composition has a viscosity less than about 25 seconds when measured by a #2 Zahn cup when formulated at a VOC level of 3.5 pounds/gallon.

3. The composition of claim 1 wherein the hydroxy-functional polyester is a polycaprolactone polyester polyol.

4. The composition of claim 1 wherein the at least one polyisocyanate comprises a mixture of polyisocyanates.

5. The composition of claim 4 wherein the mixture of polyisocyanates comprises polyisocyanates having isocyanate functionalities of 3, 4, 5, 6 and 7.

6. The composition of claim 4 wherein the polyisocyanate mixture has an average functionality of 4.1.

7. The composition of claim 1 wherein the polyisocyanate is present at a level to provide about 0.3 to about 2.0 equivalents of isocyanate for each equivalent of active hydrogen from the hydroxy-functional acrylic polymer and the hydroxy-functional polyester.

8. The composition of claim 1 wherein the polyisocyanate is present at a level to provide about 0.7 to about 1.3 equivalents of isocyanate for each equivalent of active hydrogen from the hydroxy-functional acrylic polymer and the hydroxy-functional polyester.

9. The composition of claim 1 wherein the metal catalyst is a tin compound.

10. A curable composition comprising (on a weight solids basis of the vehicle solids):
(i) 30% to 70% of a hydroxy functional acrylic polymer having a number average molecular weight less than about 5,000, and preferably less than 3,000;
(ii) 20% to 50% parts by weight of a hydroxy-functional polyester polyol;
(iii) 10-55% of a polyisocyanate;
(iv) at least 0.01% of a tin catalyst compound; and
(v) 0.1 to about 3.0% propionic acid.

12. The composition of claim 11 wherein the composition has a viscosity less than about 25 seconds when measured by a #2 Zahn cup when formulated at a VOC level of 3.5 pounds/gallon.

13. A multi-layer automotive coating composition comprising:
(i) a pigmented basecoat; and
(ii) a clearcoat applied over the basecoat, said clearcoat comprising a curable composition comprising a solvent solution of a mixture comprising:
(a) at least one hydroxy-functional acrylic polymer having a Tg of about 25° or lower;
(b) at least one hydroxy-functional polyester having a Tg of 0° or lower;
(c) at least one polyisocyanate having an average isocyanate functionality of ≧4;
(d) a metal catalyst for accelerating the isocyanate/hydroxyl reaction; and
(e) propionic acid.

14. The composition of claim 13 wherein the hydroxy-functional polyester is a polycaprolactone polyester polyol.

15. The composition of claim 13 wherein the at least one polyisocyanate comprises a mixture of polyisocyanates.

16. The composition of claim 15 wherein the mixture of polyisocyanates comprises polyisocyanates having isocyanate functionalities of 3, 4, 5, 6 and 7.

17. The composition of claim 15 wherein the polyisocyanate mixture has an average functionality of 4.1.

18. The composition of claim 13 wherein the polyisocyanate is present at a level to provide about 0.3 to about 2.0 equivalents of isocyanate for each equivalent of active hydrogen from the hydroxy-functional acrylic polymer and the hydroxy-functional polyester.

19. The composition of claim 13 wherein the polyisocyanate is present at a level to provide about 0.7 to about 1.3 equivalents of isocyanate for each equivalent of active hydrogen from the hydroxy-functional acrylic polymer and the hydroxy-functional polyester.
